(19) United States
(12) Patent Application Publication
(10) Pub. No.: US 2024/0229749 A1
(43) Pub. Date: Jul. 11, 2024

(54) Cyclonic Flow Air Cleaner Assemblies

(71) Applicant: FNA Group, Inc., Pleasant Prairie, WI (US)

(72) Inventors: Chris Alexander, Park Ridge, IL (US); Richard J. Gilpatrick, Burlington, WI (US); Peter Alex Streblow, Fond du Lac, WI (US)

(21) Appl. No.: 18/400,833

(22) Filed: Dec. 29, 2023

Related U.S. Application Data
(60) Provisional application No. 63/478,651, filed on Jan. 5, 2023.

(51) Int. Cl. F02M 35/02; F02M 35/022; F02M 35/024; F02M 35/09; F02M 35/10

(52) U.S. Cl. CPC F02M 35/0201; F02M 35/0223; F02M 35/02483; F02M 35/09; F02M 35/10262; F02M 35/1017

(57) ABSTRACT

An air cleaner assembly having an oblong cross section shape and is shaped to cooperate with non-circular air filters. An intake tunnel passes around a portion of an exterior of a filter housing body and overlies an air inlet into the filter housing body. The intake tunnel initiates rotational or cyclonic movement of air directed into the filter assembly. A cover cooperates with a longitudinal end of the filter housing assembly and allows access to the non-circular air filter. The air cleaner assembly is constructed to allow visual inspection of the interior of the air cleaner assembly. The air cleaner assembly includes a filter body support that defines an air duct that communicates filtered air toward an underlying power tool or internal combustion engine and that at least partially supports the air filter assembly relative to the underlying equipment.

### CROSS-REFERENCE TO RELATED APPLICATIONS

This application claims priority to U.S. Provisional Patent Application Ser. No. 63/478,651 filed on Jan. 5, 2023 titled “Cyclonic Air Filtration System” and the disclosure of which is incorporated herein.

### BACKGROUND OF THE INVENTION

The present invention generally relates to portable ambient air consuming power tools and devices such as air compressors and material sprayers as well as various tools or machines powered by the operation of an internal combustion engines such as plate compactors, lawn mowers, wood splitters, go carts, and the like. More particularly, the present invention is directed to air cleaner assemblies that are constructed to generate a cyclonic flow and filter the ambient air before it is communicated to an underlying tool, device, and/or engine.

Electrically powered devices such as material sprayers, air compressors, and the like intake ambient air to generate a desired material spray and/or volume of compressed air. Many such devices employ some form of filtration of the ambient air stream to prolong operation of the underlying tools or devices and/or to mitigate pollution of the resultant material spray and/or compressed air flows. Failure to adequately attend to the ambient air filtration system can cause undesirable loading of the power or motor systems of such devices and/or the undesirable ingestion of dust, dirt, or debris that may be carried on the ambient air stream into underlying assemblies of such devices such as pneumatic switches, regulators, or the like.

Operation of portable internal combustion engine powered devices, such as generators, plate compactors, lawn mowers, etc. also require the ingestion of ambient air to facilitate the combustion process. Such devices also employ air cleaner assemblies to mitigate the communication of dust, dirt, debris, and small particulate matter to the underlying systems, such as carburetors, fuel or throttle bodies, crank cases, combustion cylinders, etc. associated with operation of the engine. Desired operation of the fuel and engine systems requires communication of an adequate flow of sufficiently filtered ambient air prior to delivery of the ambient air to the fuel and underlying portions of the engine assembly. Failure to adequately attend to the desired operation of the air cleaner assembly can detrimentally affect operation of and/or damage components of the underlying fuel and internal combustion engine systems and components.

During engine operation, dirt, dust, and debris carried on ambient air flows proximate the engine operating environment can be undesirably drawn into the air filter assembly. The relative degree of dirt, dust, and debris associated with the operating environment can vary widely depending at least in part on the underlying modality associated with operation of the internal combustion engine and equipment attenuate thereto. For instance, lawn mowers, plate compactors, and the like tend to create considerable airborne debris such as dust, dirt, sand, and grass clippings proximate the operating environment whereas more stationary equipment, such as portable engine powered generators, compressors, pumps, or the like create far less airborne debris proximate the engine operating environment.

Regardless of the relative degree of pollutants carried on the ambient air flows, once drawn into the air cleaner assembly, the polluted stream of ambient environment combustion air is directed through a filter media, air filter assembly, or air filter contained within the air cleaner housing assembly prior to being communicated to the underlying engine. Debris and particulate matter carried upon the flows drawn into the air cleaner assembly must be removed from the combustion air flow prior to communication of the combustion air flows to the underlying operating systems of the internal combustion engine. Failure to properly maintain a desired operating condition of the air filter and internal spaces of the air filter housing or air cleaner assembly can lead to premature fouling and/or soiling of the air filter itself as well as the underlying fuel delivery and combustion systems associated with the internal combustion engine. Prolonged inattention to the operational condition of the air filter and/or air cleaner assembly can result in inoperability and/or destruction of the underlying internal combustion engine and/or discrete parts or portions thereof.

Various approaches have been taken to manipulate the operating characteristics associated with portable engine air cleaner assemblies. One such approach entails manipulating the air flow within the air filter assembly into a cyclonic flow prior to passage of the air flow through an air filter. The approach provides an air filter and an air cleaner housing having a circular cross section relative to a longitudinal length of the air filter and the air cleaner housing assemblies and a number of discrete flow passages within the air cleaner housing that are constructed to direct the cyclonic air flow in radial directions through the air filter or air filter media. The various flow passages defined by the air cleaner housing define various flow constrictions that are subject to fouling or plugging as dirt and debris collects therein. Such fouling of the air cleaner assembly is exacerbated when the environment and/or nature of operation of the underlying portable power tool contributes to the generation of airborne debris. Such fouling limits the portion of the air filter media that is available for filtration during operation of the underlying equipment. Further, the circular shape of the air filter and air cleaner housing limits the surface area of the air filter that is available for filtering operations. Further still, such an approach leads to progressive fouling of the filter media in directions around the filter media progressing away from the intake passage defined by the air cleaner housing toward an outlet defined by the filter housing rather than employing more uniform and thereby fuller utilization of the available surface area of the air filter.

Still other approaches to improve the duration associated with air cleaner operation rely on simply increasing the size of the air filter media and respective air cleaner housing. Such approaches increase manufacturer and end user costs attenuate to filter media replacement. Such approaches, in increasing the period between air filter service operations, further increase the potential for service of the air filter system being overlooked. Both approaches also overlook other concerns associated with the operation, storage, and use of the portable electrically or internal combustion engine powered portable equipment.

Whether employed as a self-powered driven device, such as lawn mowers, other wheeled engine driven equipment, or plate compaction devices, or manually movable devices, such as portable generators, compressors, or the like, such equipment is often stored and frequently operated in close proximity to other equipment, obstacles, structures or the like. Approaches that simply employ enlarging the cross-sectional shape or volume of the air cleaner assembly to prolong periods between service events and/or to maintain a desired throughput associated with operation of the air cleaner assembly commonly leave the structure of the air cleaner assembly more exposed to inadvertent contact with other structures. Inadvertent contact with the air cleaner assembly can damage the air cleaner assembly and/or dissociate the air cleaner assembly from its desired association with the underlying engine components. If substantial enough, such impacts can further result in failure or fracture of the air cleaner assembly housing and/or dissociation of sealing interfaces between discrete portions thereof. Such impacts can create undesired flow passages wherein unfiltered ambient air can pass to the underlying engine to portable tool systems.

As alluded to above, desired engine operation relies in part on the communication of a desired amount of ambient air through the air filter assembly and the communication of ambient air through the cleaner assembly with a suitable degree of debris having been removed therefrom. The collection of dirt and debris in the air filter and the air filter housing assembly detrimentally affects the volume of sufficient filtered air that can be communicated therethrough. Further still, without expedient removal of larger air born debris that may be carried on the ambient air flow and ingested into the air cleaner assembly may break-up during operation of the underlying portable powered device due to vibrations attenuate to operation of the engine and/or portable powered device and/or the continued flow of ambient air thereover.

Atomization of debris or larger particulate matter that makes its way into the air cleaner assembly tends to cause premature fouling of the air filter assembly and/or demands more frequent servicing of the air cleaner assembly to maintain a desired operating condition of both the air filter or air filter media, the air cleaner assembly, and/or the underlying portable power tool or internal combustion engine associated therewith. Commonly, disassembly of the air cleaner assembly and/or user dissociation of the air filter media from the air cleaner assembly is required to ascertain the relative degree of fouling of the air filter or air filter media and/or to ascertain the presence of any undesired larger particulate matter within the volume defined by the air cleaner assembly. Some approaches to mitigate ingestion of larger particulate matter into the air filter assembly simply provide supplemental filter medias disposed over ambient air inlets of the air filter assemblies. Such approaches tend to increase manufacturer and end user costs by requiring multiple discrete air filters, complicate air filter and air cleaner assembly service operations, and increase down times associated with maintaining a desired operating condition of the air filter and air cleaner assemblies associated with the portable power tools.

Accordingly, there is a need for an air cleaner assembly that can be economically employed between various portable power tools and/or portable internal combustion engine powered tools or devices and that efficiently communicate filtered ambient air through the air cleaner assembly while efficiently separating dirt, dust, or debris and/or particulate matter from the cleaner assembly. There is a further need for an air cleaner assembly that has a robust construction and does not unduly interfere with user interaction with the operating mechanisms associated with underlying systems of the portable power tool and/or internal combustion engine associated therewith. There is a further need for an air cleaner assembly that is constructed to cooperate with portable engine powered devices such that the air cleaner assembly is better protected from incidental impacts. There is a further need for an air cleaner assembly that accommodates ready inspection of the internal spaces and components of the air cleaner assembly without disassembly and/or interaction with the air cleaner assembly.

### SUMMARY OF THE INVENTION

The present invention discloses an air cleaner assembly that resolves one or more of the drawbacks disclosed above. One aspect of the present invention discloses an air cleaner assembly having an oblong cross section shape and that is shaped to cooperate with non-circular or oblong air filters. The air cleaner assembly includes an intake tunnel that passes around a portion of an exterior of a filter housing body and that overlies an air inlet into the filter housing body. The intake tunnel initiates rotational or cyclonic movement of air directed into the cleaner assembly. A cover moveably cooperates with a longitudinal end of the filter housing assembly and allows selective access to the non-circular air filter. The air cleaner assembly is constructed to allow visual inspection of the interior of the air cleaner assembly without operation of the cover. The air cleaner assembly includes a filter housing mount that defines an air duct that communicates filtered air toward an underlying power tool or internal combustion engine and that at least partially supports the air cleaner assembly relative to the underlying equipment. During operation of the air cleaner assembly, intake air, and debris carried thereupon, enters the air cleaner assembly and is directed initially toward a debris collection port and subsequently in a cyclonic direction about the air filter such that the air flow preferably circumscribes the air filter prior to passing radially through the air filter and toward the underlying portable powered tool or device.

Another aspect of the present invention discloses an air cleaner assembly having a filter housing assembly that is defined by a longitudinal axis and has an oblong cross section shape that extends along the longitudinal axis such that the filter housing assembly defines a cavity shaped to receive a non-circular air filter. An elongate intake opening is formed along a portion of the filter housing assembly and a discharge opening is formed in a longitudinal end of the filter housing assembly that is fluidly connected to the cavity and radially offset from the elongate intake opening such that air moving from the elongate intake opening toward the discharge opening moves circumferentially about the cavity before passing through a non-circular air filter disposed therein.

A further aspect of the present invention that is usable or combinable with one or more of the features or aspects disclosed above discloses an air cleaner assembly having a filter housing defined by a first end and a second end and a non-circular wall extending therebetween. The non-circular wall is defined by respective opposing curved ends and generally planar sections therebetween such that the filter housing is shaped to receive a non-circular air filter therein. An air inlet is formed through the non-circular wall and a cover is movably connected to the first end of the filter housing and shaped to allow a non-circular air filter to be associated with a cavity defined by the filter housing. An air outlet is formed in the second end of the filter housing such that a cyclonic air flow is generated between the housing and a non-circular air filter disposed in the cavity. The air cleaner assembly includes an inspection window that allows visual inspection of the cavity and/or an air filter disposed in the cavity when the cover is closed and/or secured. In a preferred aspect, the inspection window is provided by constructing the cover or a portion thereof of a translucent or transparent material.

Another aspect of the present invention that is usable or combinable with one or more of the above features or aspects discloses a method of forming an air cleaner assembly for portable power tools. The method provides a filter housing that is defined by a longitudinal axis and an oblong cross section shape along the longitudinal axis such that the filter housing is shaped to receive a non-circular air filter. An outlet is formed in an end wall of filter housing and an inlet passage is formed in an edge wall of the filter housing. An intake tunnel that extends over the inlet passage and extends in a circumferential direction about a portion of the filter housing is shaped to initiate rotation of air communicated toward the inlet passage.

These and other aspects, features, and advantages of the present invention will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a perspective view of an air cleaner assembly according to one embodiment of the present invention;

FIG. 2 is also a perspective view the air cleaner assembly shown in FIG. 1;

FIG. 3 is a perspective view of a first equipment facing side of the air cleaner assembly shown in FIG. 1-2;

FIG. 4 is a perspective view of a second equipment facing side of the air cleaner assembly shown in FIG. 1-3;

FIG. 5 is an exploded perspective view of the air cleaner assembly shown in FIGS. 1-4;

FIG. 6 is a perspective view of a shroud exploded from the filter housing of the air cleaner assembly shown in FIGS. 1-5;

FIG. 7 is a perspective view of the filter housing shown in FIG. 6;

FIG. 8 is a perspective view the filter housing with the air filter or air filter media exploded therefrom;

FIG. 9 is a perspective view of the air filter housing with an filter housing support exploded therefrom of the air cleaner assembly shown in FIGS. 1-5;

FIG. 10 is a perspective view of an equipment facing side of the air filter housing support shown in FIG. 9;

FIG. 11 is a perspective view of an air filter facing side of a cover of the air cleaner assembly shown in FIGS. 1-2;

FIG. 12 is a cross section elevation view of the air cleaner assembly shown in FIGS. 1-5 taken along line 12-12 shown in FIG. 16 and normal to the longitudinal axis defined by the filter housing of the air cleaner assembly;

FIG. 13 is a perspective cross section view taken along line 13-13 shown in FIG. 1 and coincident with the longitudinal axis defined by the filter housing of the air cleaner assembly;

FIG. 14 is a perspective view of the air cleaner assembly shown in FIGS. 1-5 associated with an exemplary underlying internal combustion engine;

FIG. 15 is a top plan view of the assembly shown in FIG. 14;

FIG. 16 is a first side elevation view of the assembly shown in FIG. 14;

FIG. 17 is a second side elevation view of the assembly shown in FIG. 14;

FIG. 18 is third side elevation view of the assembly shown in FIG. 14;

FIG. 19 is a fourth side elevation view of the assembly shown in FIG. 14;

FIG. 20 is a view similar to FIG. 1 of an air cleaner assembly according to another embodiment of the present invention;

FIG. 21 is a perspective view of an equipment facing side of the air cleaner assembly shown in FIG. 20;

FIG. 22 is a side elevation view of the air cleaner assembly shown in FIG. 20;

FIG. 23 is top perspective view of an air filter housing support of the air cleaner assembly shown in FIG. 20;

FIG. 24 is an elevation view of an equipment facing side of the air filter housing support shown in FIG. 23;

FIG. 25 is a perspective view of the air cleaner assembly shown in FIG. 20 engaged with an exemplary underlying internal combustion engine;

FIG. 26 is a top plan view of the assembly shown in FIG. 25;

FIG. 27 is a first side elevation view of the assembly shown in FIG. 25;

FIG. 28 is a second side elevation view of the assembly shown in FIG. 25; and

FIG. 29 is a third side elevation view of the assembly shown in FIG. 25.

### DETAILED DESCRIPTION

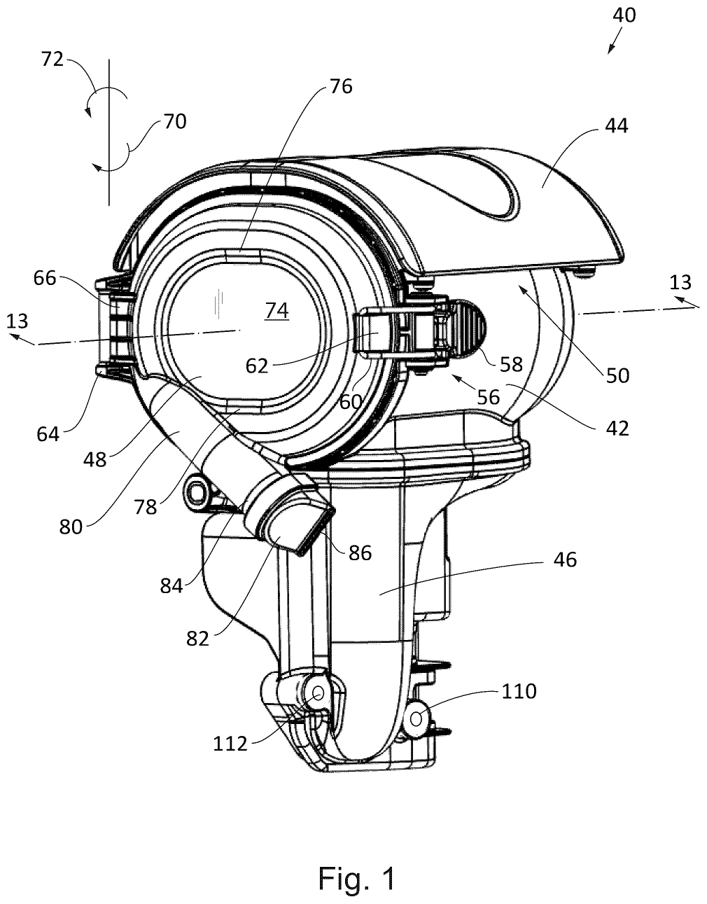

FIGS. 1-4 show various perspective views of an air cleaner assembly 40 according to one embodiment of the present invention. Referring to FIGS. 1-4, air cleaner assembly 40 includes an air filter housing 42, an exterior wall or shroud 44 that extends about a portion thereof, a filter housing support 46 that extends generally under the filter housing 42, and a cover 48 that is movably connected to filter housing 42 to allow selective access to an internal cavity defined thereby. As disclosed further below, cover 48 is moveably connected to filter housing 42 to allow selective removal and/or replacement of an air filter, air filter media, or air filter assembly from the cavity defined by the air filter housing 42. As disclosed further below, the air filter assembly has an oblong or non-circular cross section shape that is generally similar to but smaller than a cross section shape of the cavity defined by the air filter housing. Compared to elongate air filter assemblies having circular cross section shapes, non-circular or oblong air filter assemblies provide greater surface area associated with the passage of air in radial directions through the filter assembly and are thereby capable of greater service life and/or durations of operation between service events.

Shroud 44 is maintained in an offset or spaced relation relative to filter housing 42 to generally define an intake tunnel 50 disposed therebetween. When fully assembled and during operation, ambient air from the operating environment is drawn into air cleaner assembly 40 via intake tunnel 50 prior to passing into a cavity defined by air filter housing 42. As disclosed further below, ambient air ingested into air cleaner assembly 40 moves in a horizontally oriented cyclonic manner about the air filter assembly prior to passing radially through the air filter assembly and being directed out of the air filter housing 42 for subsequent consumption or usage by an underlying device, power tool, or portable internal combustion engine.

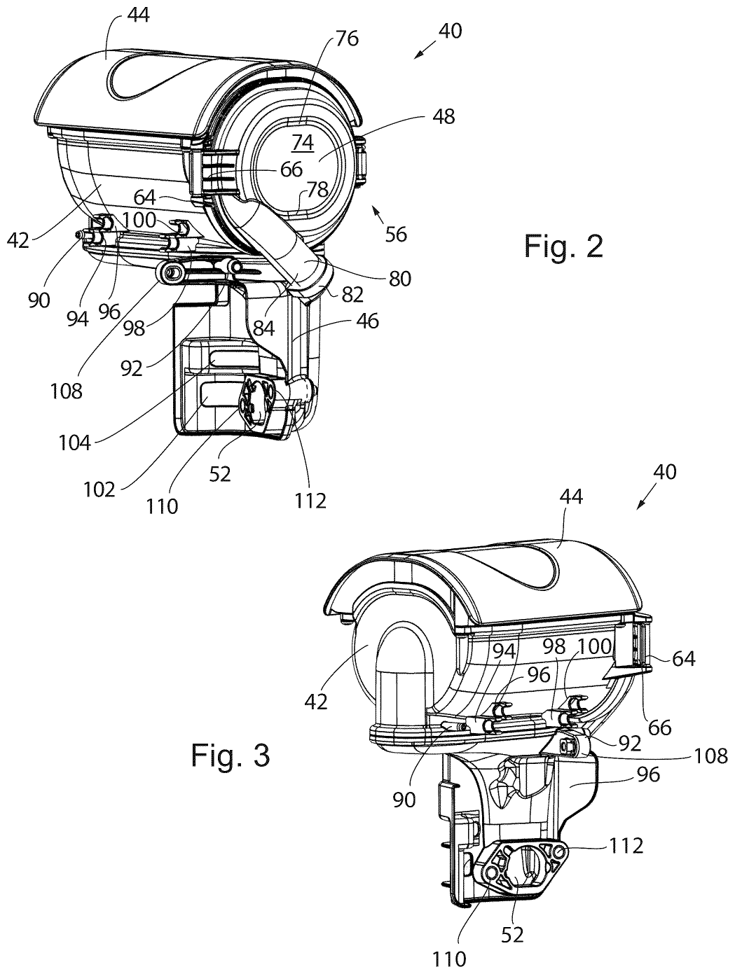

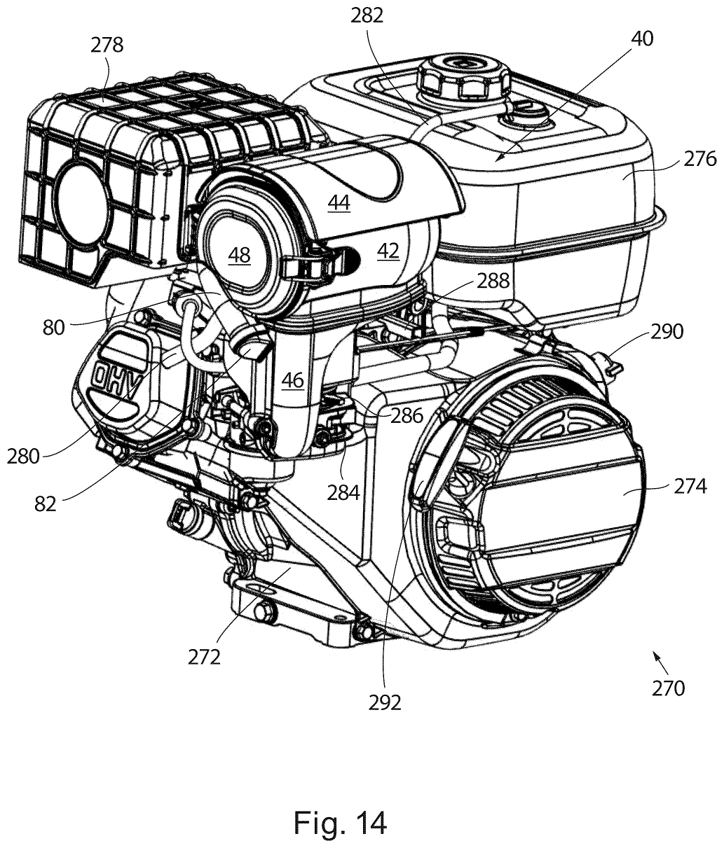

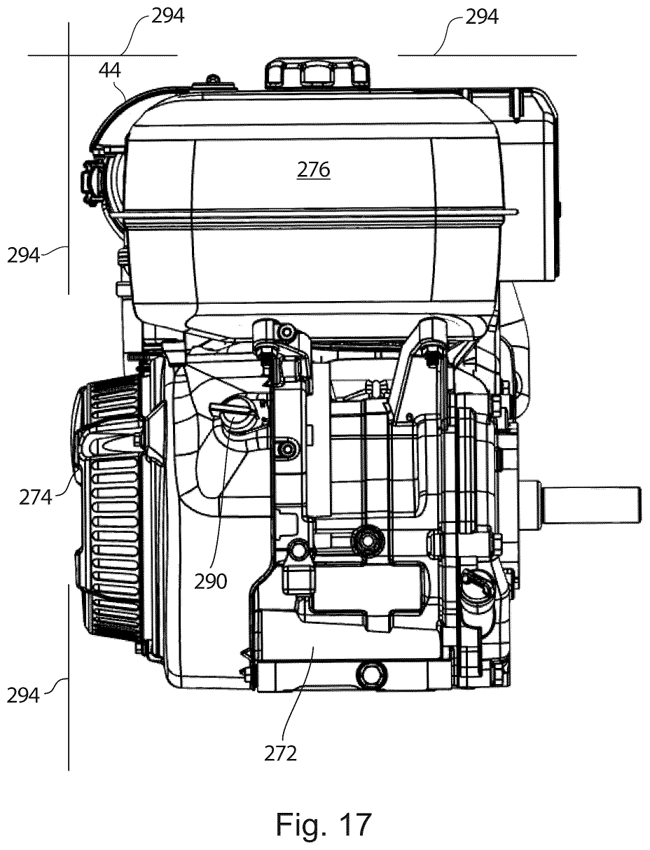

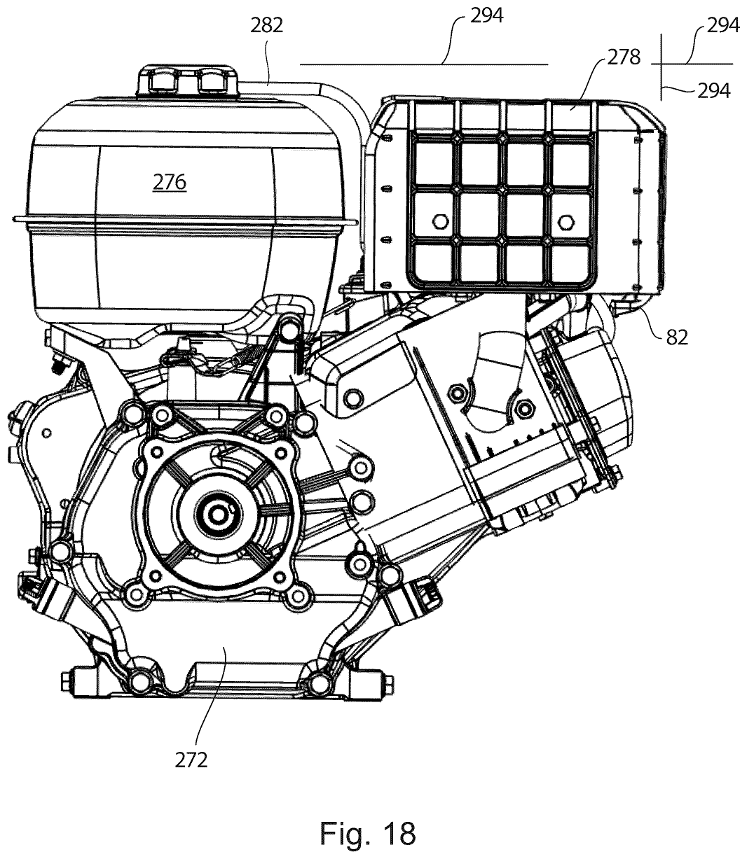

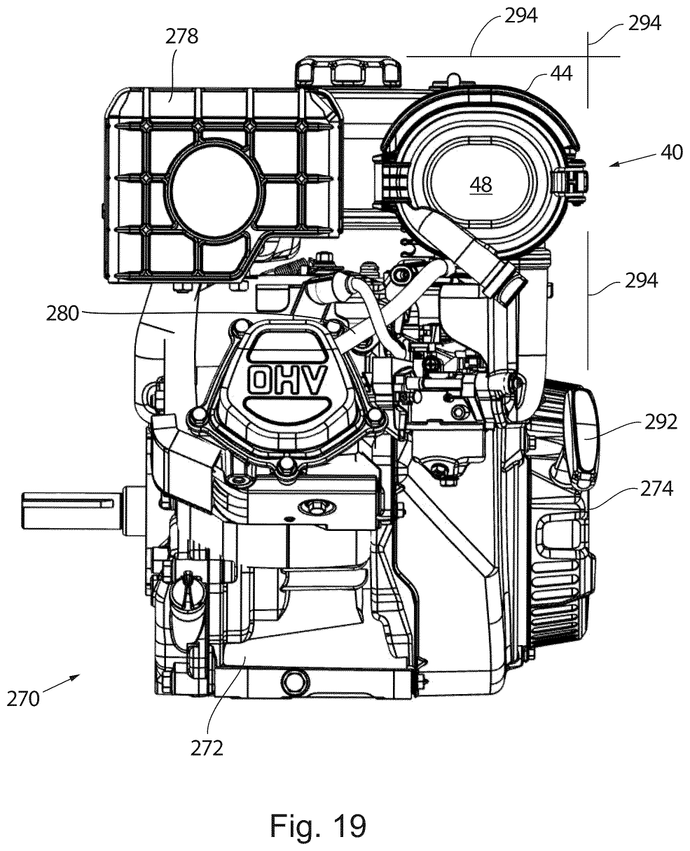

When passing through the air cleaner assembly 40, development of the horizontally oriented cyclonic flow and cooperation of the air flow with various debris capturing and/or directing structures, enhances filtration performance and service life duration of the air cleaner assembly and air filter assemblies associated therewith. As disclosed further below with respect to FIGS. 14-19, when employed for interaction with an underlying portable internal combustion engine, ingested ambient air does not exit air cleaner assembly 40 until reaching an outlet 52 (FIGS. 2 and 3) defined by filter housing support 46. Outlet 52 is constructed to be fluidly connected to an air intake defined by a throttle body of an underlying portable internal combustion engine and thereby mitigates undesired communication of unfiltered ambient air into the workings of underlying equipment. A surface 53 associated with the underlying equipment facing side of filter housing support 46 that extends about outlet 52 has a substantially planar construction and accommodates a preferably sealed and structurally robust operative engagement of filter housing support 46, and outlet 52 defined thereby, with an intake portion of the fuel delivery system or throttle body of an underlying internal combustion engine.

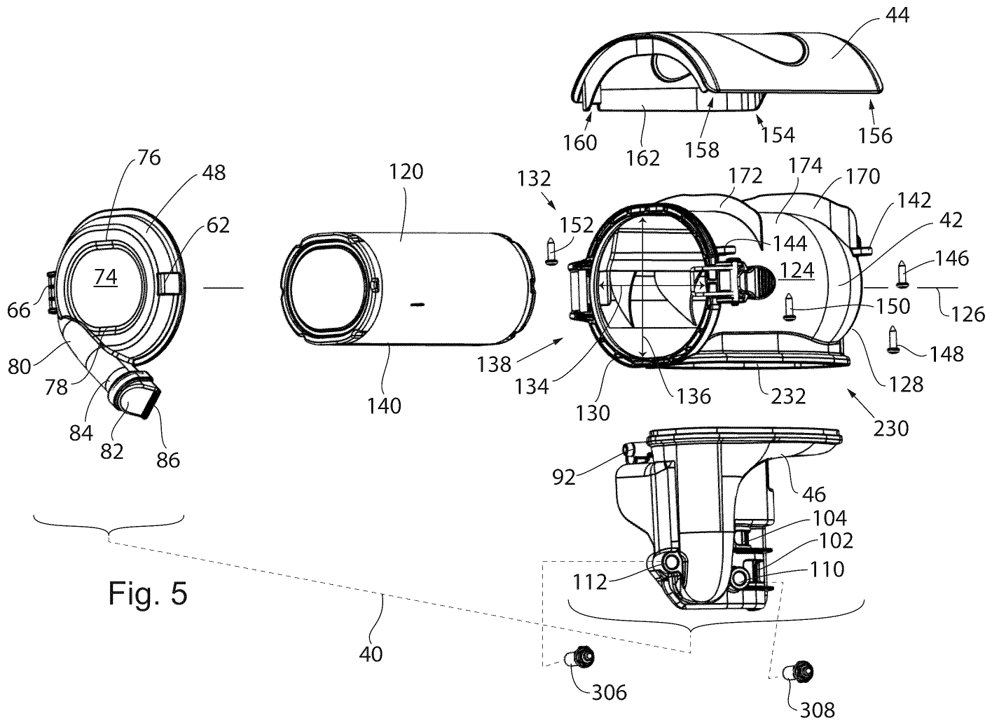

Still referring to FIGS. 1-4, a latch assembly 56 is pivotably connected filter housing 42. Latch assembly 56 includes an operator 58 and a catch 60 that selectively engages a boss 62 defined by cover 48. A pivot mount 64 is defined by filter housing 42 and is oriented at a circumferentially opposite side thereof relative to latch assembly 56. Pivot mount 64 is constructed to cooperate with an arm 66 defined by cover 48 and that is positioned circumferentially opposite boss 62. As disclosed further below with respect to FIG. 5, latch assembly 56 is selectively operable to allow catch 60 to be engaged and disengaged from boss 62 such that cover 48 is rotational relative to filter housing 42 in a respective opening direction, indicated by arrow 70 (FIG. 1), and a closing direction, indicated by arrow 72 (FIG. 1).

When cover 48 is oriented in the closed position relative to filter housing 42 as shown in FIG. 1, engagement of arm 66 with pivot mount 64, and cooperation of catch 60 with boss 62, provides a sealed interface of cover 48 with filter housing 42. When latch assembly 56 is oriented in the open position such that catch 60 can be disengaged from boss 62, cover 48 is rendered rotational in opening direction 70 relative to filter housing 42 such that cover 48 can attain a position wherein cover 48 is disposed outside of a footprint defined by the cavity associated with filter housing 42. When oriented in the open position, an air filter or air filter assembly disposed in filter housing 42 can be removed from and/or associated with the cavity defined by filter housing 42 when necessary or desired.

It is further appreciated that arm 66 of cover 48 may be selectively disengaged from pivot mount 64 associated with filter housing 42 should cover 48 become damaged and/or otherwise need to be replaced. Preferably, arm 66 and pivot mount 64 cooperate with one another in such a manner wherein manual translation of cover 40 relative to filter housing 42 in an axial direction aligned with a longitudinal axis of filter housing 42 is required to facilitate disengagement of cover 48 from filter housing 42. Such a consideration mitigates unintentional or incidental separation of cover 48 from filter housing 42 during normal opening and/or closing of cover 48 relative to filter housing 42.

In a preferred embodiment, cover 48 and/or a portion or the entirety thereof, defines a viewing window 74 constructed to facilitate visual inspection of the areas behind cover 48 and internal to filter housing 42. Preferably, a portion or the entirety of cover 48 is constructed of a translucent or transparent material to accommodate visual inspection of the internal cavity of filter housing 42 without requiring opening of cover 48. Air cleaner assembly 40 may further include one or more optional light sources 76, 78 intended to illuminate the internal features of air cleaner assembly 40 and/or to assist with the visual inspection of the internal portions thereof. It is appreciated that light sources 76, 78 may be battery powered, solar powered, provided as a bioluminescent material, or powered by motion of air through air cleaner assembly 40 and/or operatively connected to a power system attenuate to equipment to which air cleaner assembly 40 is engaged.

Cover 48 of air cleaner assembly 40 further defines a debris tube 80 that extends in a generally downward direction therefrom. A one directional valve 82 is disposed at a lower distal end 84 of debris tube 80 and defines a selectively operable opening 86 at an end thereof. As disclosed further below, dirt, dust, and debris that may be ingested into air cleaner assembly 40 is directed into debris tube 80 and travels toward valve 82 so as to be expelled from air cleaner assembly 40 at selectively operable opening 86. The collection and subsequent expulsion of dirt, dust, and debris from air cleaner assembly 40 and valve 82 mitigates pollution of the air filter via more expedient expulsion of particulate matter rather than atomization of the debris during operation of the underlying tool and/or power equipment. As disclosed further below, filter housing 42 is constructed, and the air flow directed therethrough, in a manner that encourages movement of any dirt or debris ingested into the air cleaner assembly 40 toward debris tube 80 for expedient expulsion via valve 82.

Referring to FIGS. 2 and 3, when employed for operation with internal combustion engine systems, air filter housing 42 and/or filter housing support 46 can preferably include one or more passages or ports 90, 92 configured to be fluidly connected to an underlying fuel delivery system and/or engine crankcase as disclosed further below. Ports 90, 92 are configured to provide fuel and crankcase vent passages associated with reclamation of fuel vapors associated with the fuel reservoir and/or recapture of residual fuel that may bypass a previous combustion process. The residual fuel and fuel reservoir vapors are directed to the combustion chamber and thereby improves the fuel efficiency and emission performance associated with operation of the underlying internal combustion engine.

Air filter housing 42 further includes one or more optional bosses 94, 96, 98, 100 that extend in a generally lateral direction from a lower portion thereof. Bosses 94, 96, 98, 100 can be configured to snap fittingly cooperate with one or more tubes or lines associated with an underlying throttle body, provide discrete mounting locations associated with supporting respective throttle linkage members, and/or when not employed as ancillary system mounting locations, can provide a guided interface associated with user interaction with adjustable components of an underlying throttle or engine assembly such as throttle set or mount screws or the like.

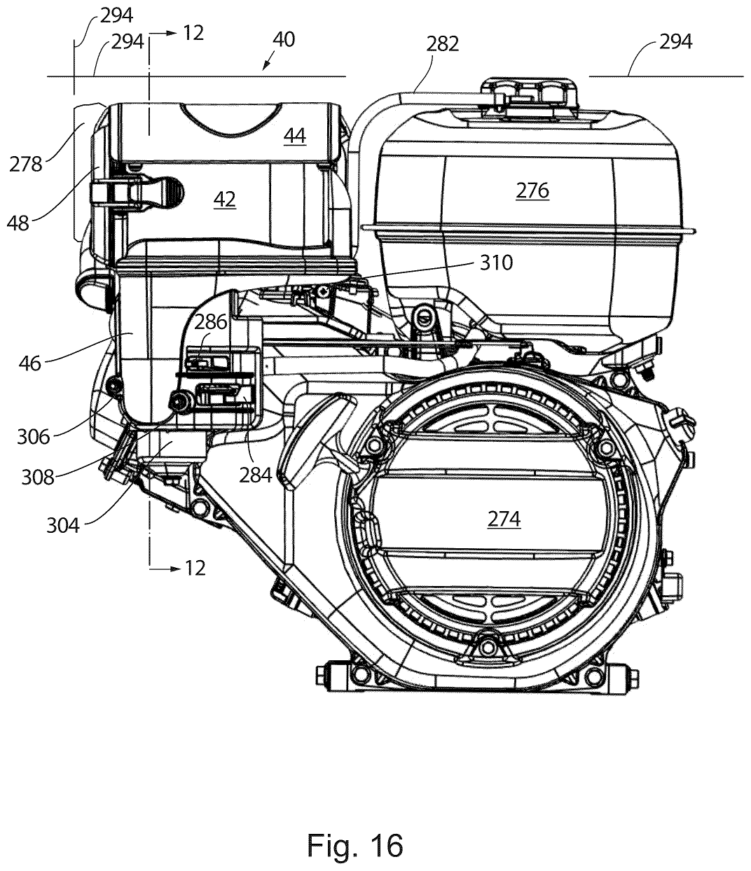

Referring to FIGS. 2-4, filter housing support 46 includes one or more openings 102, 104 shaped to cooperate with engine or fuel system adjustment mechanisms such as a fuel shut off valve lever, a choke valve lever, and/or an engine throttle adjustment lever as disclosed further below with respect to FIG. 16. Filter housing support 46 further defines one or more bosses 108 110, 112 that are positioned to provide robust or rigid mounting of filter housing support 46 relative to an underlying structure such as the throttle body assembly and or crankcase of the underlying internal combustion engine.

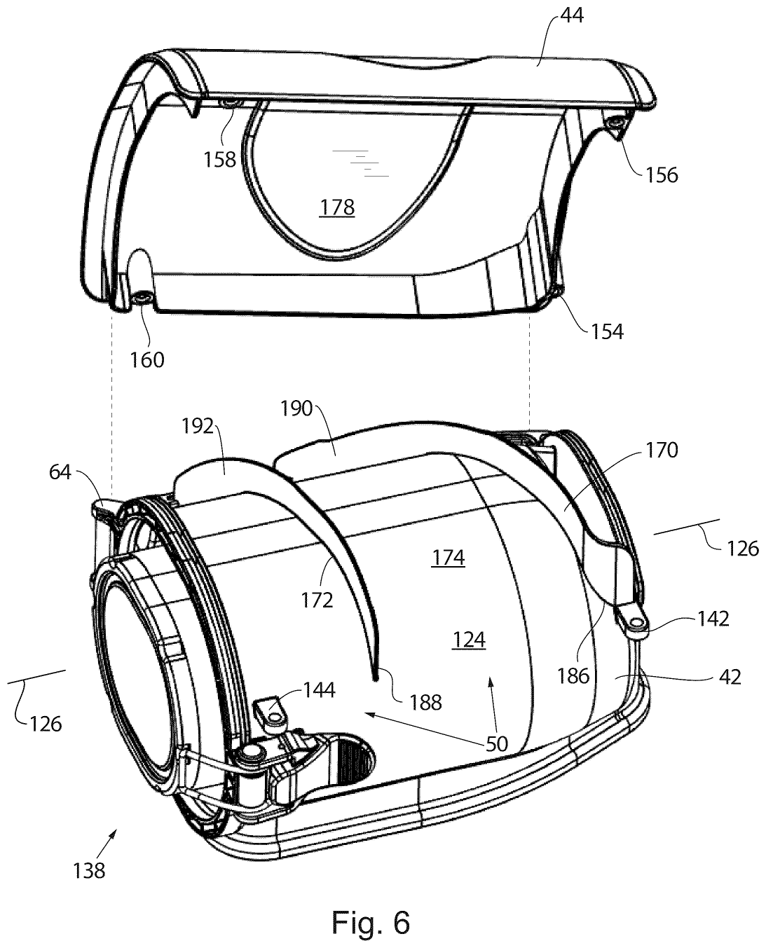

FIG. 5 is an exploded view of air cleaner assembly 40 with an exemplary air filter assembly 120 removed therefrom. Referring to FIGS. 5 and 6, filter housing 42 is defined by an elongate body 124 that extends along a longitudinal axis, indicated by line 126, between a first longitudinal end 128 and a second longitudinal end 130. As disclosed further below, end 128 of body 124 defines an outlet constructed to communicate filtered air beyond filter housing 42. End 130 has a substantially open construction that is shaped to sealingly cooperate with cover 48 when cover 48 is oriented in the closed orientation relative thereto. Body 124 of filter housing 42 is generally defined by a non-circular or oblong cross section shape 132 that extends along longitudinal axis 126 and which is defined by a major axis 134 that is horizontally oriented and a minor axis 136 that is generally vertically oriented. Body 124 defines a cavity 138 that is shaped to slidably receive and cooperate with air filter assembly 120 which is defined by a longitudinal axis and an oblong or non-circular shape 140 that extends along the longitudinal axis such that, when engaged with filter housing 42, the longitudinal axis of filter assembly 120 is aligned with and extends along longitudinal axis 126 of air cleaner assembly 40.

Body 124 of air filter housing 42 defines one or more bosses 142, 144 that are shaped to cooperate with one or more fasteners 146, 148, 150, 152 that removably cooperate with respective bosses 154, 156, 158, 160 distributed about a downward facing surface 162 of shroud 44 such that shroud 44 can be removably secured to filter housing 42. It is appreciated that other securing methodologies, such as a hinged or a snap-fittable connection may be employed to secure shroud 44 to air filter housing 42. Alternatively, shroud 44 may be integrally formed with air filter housing 42. Regardless of the connection methodology employed, shroud 44 is preferably removably connected to air filter housing 42 to accommodate replacement of shroud 44 in the event shroud 44 becomes damaged during use or operation of an underlying tool and/or equipment.

As shown in FIGS. 6-8, one or more guide walls or baffles 170, 172 extend in an upward radial direction from an exterior surface 174 of body 124 of filter housing 42 between an exterior surface 174 of filter housing 42 and a downward or interior facing surface 162 of shroud 44. It is appreciated that baffles 170, 172 could alternatively be constructed to extend from the interior facing surface 162 of shroud 44 to rest upon or be disposed in close proximity to exterior surface 174 of body 124 of filter housing 42 when shroud 44 is secured thereto. When secured to one another, areas of shroud 44 within its perimeter edge are maintained in a spaced relation relative to the exterior facing surface 174 of air filter housing 42 so as to define ambient air intake tunnel 50 formed therebetween such that intake tunnel 50 extends radially about a portion of surface 174 of air filter housing 42.

Preferably, when shroud 44 is secured to air filter housing 42, perimeter edges associated with the cooperation of shroud 44 and air filter housing 42 that are offset from the open edge defined by air cleaner intake tunnel 50 (FIG. 1) cooperate with one another in a sealing manner such that ambient air drawn into air cleaner assembly 40 is accommodated only at the open edge defined by air cleaner intake tunnel 50. In a preferred aspect, shroud 44 also includes an inspection window 178 formed as a transparent or translucent portion thereof. Whereas inspection window 74 (FIG. 1) defined by cover 48 (FIG. 1) facilitates inspection of the internal cavity 138 (FIG. 5) or air filter housing 42 and the air filter assembly 120 (FIG. 5) disposed therein, inspection window 178 facilitates visual inspection of intake tunnel 50 formed between shroud 44 and filter housing 42 when shroud 44 and filter housing 42 are secured to one another. If underlying equipment is configured for operation in generally clean environments, inspection window 178 can be omitted such that the area associated therewith can provide a decorative feature and/or a location associated with equipment and/or manufacturer source or type information such as a product placard or the like. Movable and/or removable cooperation of shroud 44 with filter housing 42 facilitates cleaning and/or removal of debris from intake tunnel 50 when necessary or desired and in a manner that does not direct the debris further into air cleaner assembly 40.

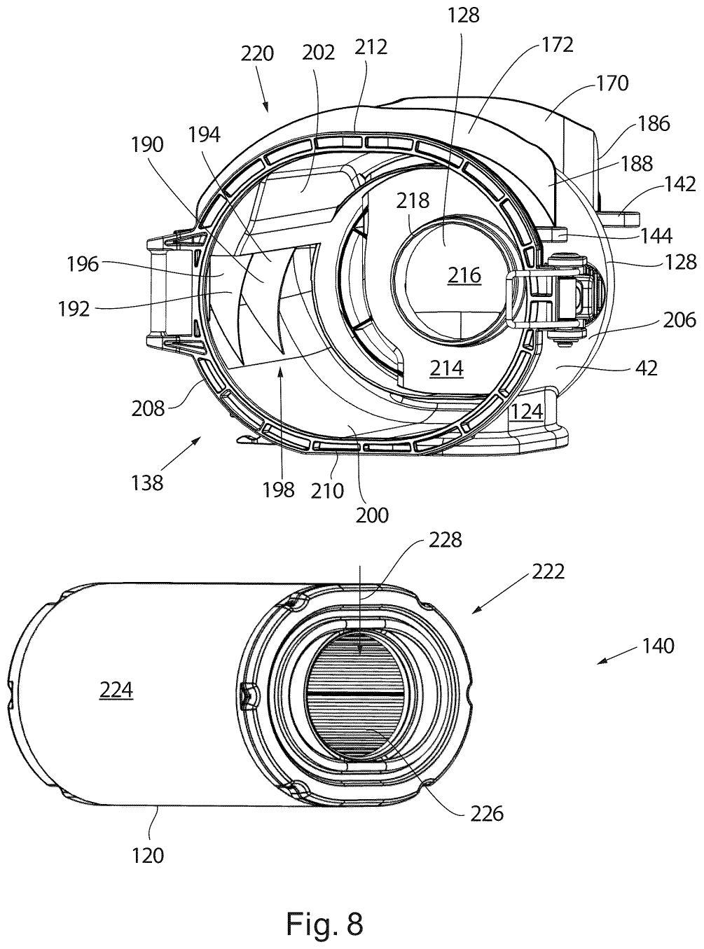

Referring to FIGS. 6-8, baffles 170, 172 progress in a helical circumferential manner about surface 174 of air filter housing 42 away from respective first ends 186, 188 and toward respective second ends 190, 192 thereof. Respective second ends 190, 192 of baffles 170, 172 are oriented relative to longitudinal axis 126 of filter housing 42 to be nearer open end 130 of filter housing 42 than respective first ends 186, 188 of respective baffles 170, 172. Second ends 190, 192 of respective baffles 170, 172 terminate at an elongate intake opening 198 (FIG. 8) formed in body 124 of filter housing 42. Ends 190, 192 do not extend beyond the cross sectional footprint defined by the noncircular or oblong elongate cavity 138 defined by an interior surface 200 of filter housing 42 a distance that would allow ends 190, 192 to interfere with the slidable cooperation of air filter assembly 120 with cavity 138 defined by air filter housing 42. Intake air passing from intake opening 198 associated with tunnel 50 of filter housing 42 passes through tunnel 50 with a rotational direction vector component and a longitudinal axial direction vector such that, as the intake air moves through tunnel 50, the intake air is directed toward the open end 130 of filter housing 42. The helical shape associated with baffles 170, 172 relative to longitudinal axis 126 of filter housing 42 creates respective areas 194, 196 of tunnel 50 between adjacent baffles 170, 172 and respective ends walls of filter housing 42 proximate second ends 190, 192 of baffles 170, 172 that are constructed to accelerate the air flow therethrough prior to passing into cavity 138 defined by filter housing 42. As disclosed further below, air ingested into air cleaner assembly 40 is provided in a helical or cyclonic flow introduced to cavity 138 and encourages centripetal separation of dirt, dust, and debris from the flow stream and encourages or accommodates collection and expulsion of debris from cavity 138 of air filter housing 42 as disclosed further below.

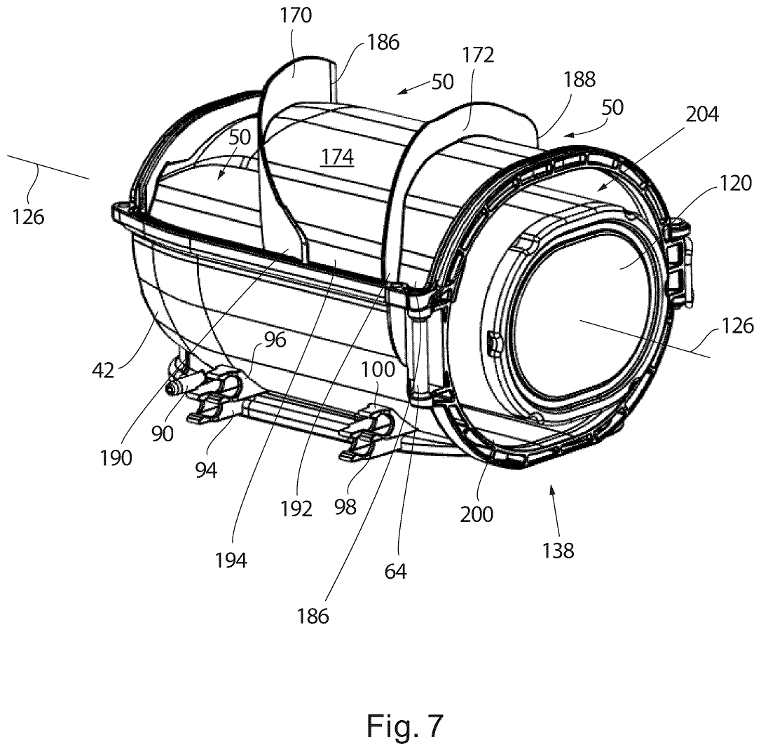

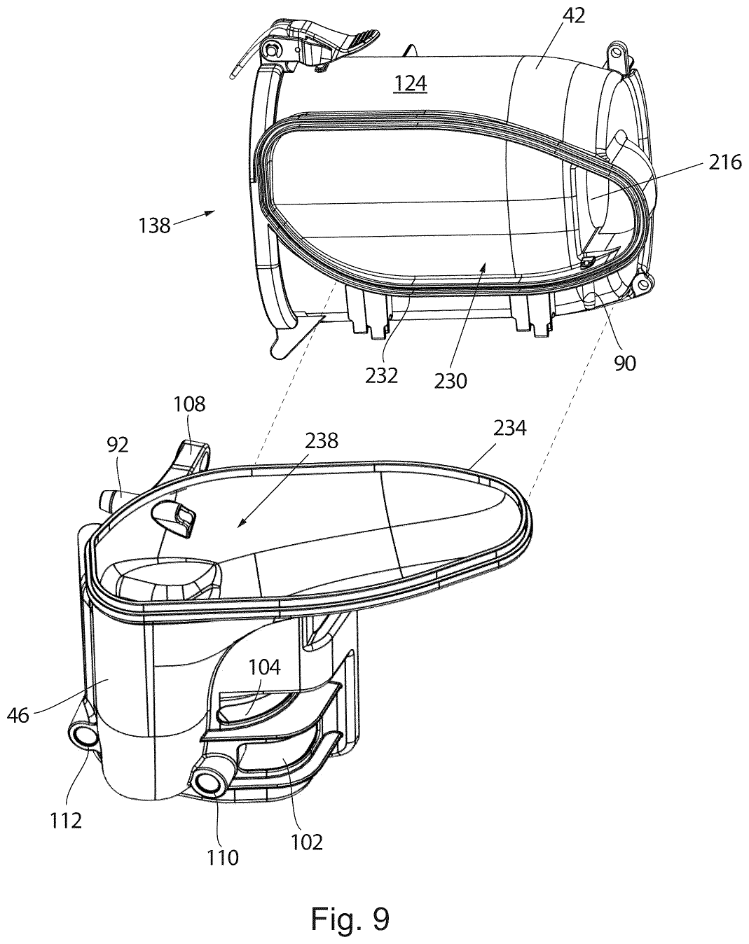

Referring to FIGS. 7 and 8, a circumferential gap 204 is maintained between air filter assembly 120 and interior surface 200 of air filter housing 42 when air filter assembly 120 is disposed therein. A diverter or ramped surface or wall 202 extends in a longitudinal direction along interior surface 200 of air filter housing 42 and in an inward radial direction to direct the air flow that impinges thereupon in an inward radial direction toward air filter assembly 120 as the flow passing therearound reapproaches inlet 198. It is further appreciated ramped wall 202 can be tapered to impart axial translation of debris carried upon the circulating air flow toward a debris catch defined by an interior surface of cover 48 as disclosed further below with respect to FIG. 9 such that ramped wall 202 is configured to assist with debris separation and encourage passage of the air flow in a radial direction through air filter assembly and toward an outlet of air filter housing 42. Still referring to FIG. 8, body 124 air filter housing 42 is defined by generally arcuate or curved opposing edge walls 206, 208 and generally more planar walls 210, 212 that extend therebetween so as to define a generally oblong or non-circular cross section shape of cavity 138 of filter housing 42. A partition 214 defined by end 128 of body 124 of filter housing 42 includes an opening 216 that is formed therethrough. A flange or rib 218 extends from partition 214 toward the opening 220 defined by opposing end 130 of filter housing 42. Partition 214 and rib 218 are constructed to cooperate with a first end 222 of air filter assembly 120 and provides a sealed interaction therebetween when air filter assembly 120 is engaged with air filter housing 42.

Non-circular air filter assembly 120 includes a dust cover 224 disposed over a reinforcement member (not visible) that is disposed over a pleated or accordion type filter media 226. During use of air cleaner assembly 40, air introduced into filter housing 42 via inlet 198 passes circumferentially about filter assembly 120 and subsequently passed radially, indicated by arrow 228, through filter assembly 120 before exiting cavity 138 of filter housing 42 at opening 216 defined by air filter housing 42. As disclosed further below, during bench testing using talc as a debris carried upon the flow, it was verified that flow introduced to cavity 138 made at least one full revolution about non-circular filter assembly 120 while in gap 204 (FIG. 7) defined between interior surface 200 of filter housing 42 and the exterior surface of air filter assembly 120. As disclosed further below, the cyclonic flow through air cleaner assembly 40, and the axial vector associated therewith, improves movement, velocity, and circulation of debris carried upon the air stream toward debris tube 80 (FIG. 1) defined by cover 48.

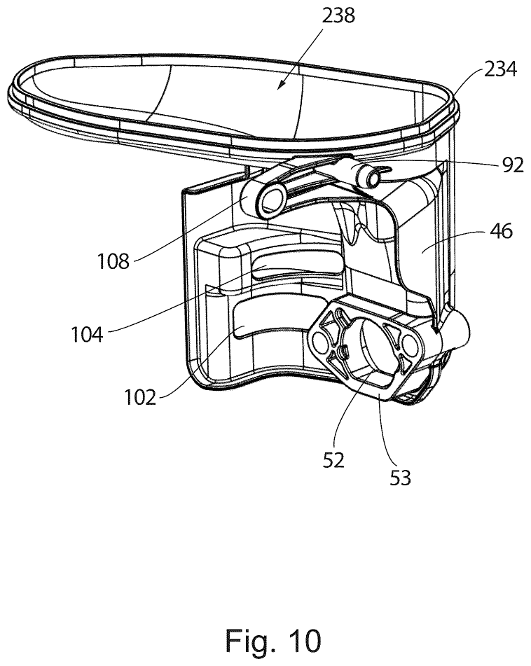

Referring to FIGS. 9 and 10, filtered air passing through opening 216 defined by filter housing 42 passes through a downward facing cavity 230 defined by body 124 of filter housing 42. Cavity 230 is bounded by a flange or a skirt 232 that extends in an outward radial direction about cavity 230. Skirt 232 of filter housing 42 is shaped and constructed to sealingly cooperate with a flange or lip 234 defined by filter housing support 46. Skirt 232 and lip 234 are shaped to provide an indexing configuration and accommodate ready association of filter housing 42 and filter housing support 46 when engaged with one another. Optional vent or port 92 formed in filter housing support 46 accommodate a crankcase vent and communicate crankcase gases, and any unspent fuel associated therewith, to an internal cavity or passage 238 of filter housing support 46 and communicate flows received from air filter housing 42 and vent 92 toward outlet 52. As disclosed further below, when configured for operation with an internal combustion engine, outlet 52 is configured to be connected to an inlet of carburetor or a inlet throttle body assembly associated with an underlying engine.

As disclosed above, air cleaner assembly 40 may be employed to provide filtered air communicated to portable electrically powered equipment such as compressors, material sprayers, and the like. When employed in such a manner, it is appreciated that the construction of filter housing support 46 may be integrated into the construction of the underlying device. That is, the underlying compressor, material sprayers, or the like may be constructed to include a housing that defines an air inlet and has a flange or lip shaped to sealingly cooperate with skirt 232 defined by air filter housing 42 thereby providing a mating structure similar to that provided by air filter housing support 46 shown in FIG. 9. It is further appreciated that such equipment may alternatively be constructed to be connected to outlet 52 defined by air filter housing support 46. It is further appreciated that when employed for cooperation with portable electrically powered tools or devices, vent 92 may be omitted for when underlying equipment does not require venting or communication of flow positive or negative pressure signals to or from the underlying equipment and/or control systems associated therewith.

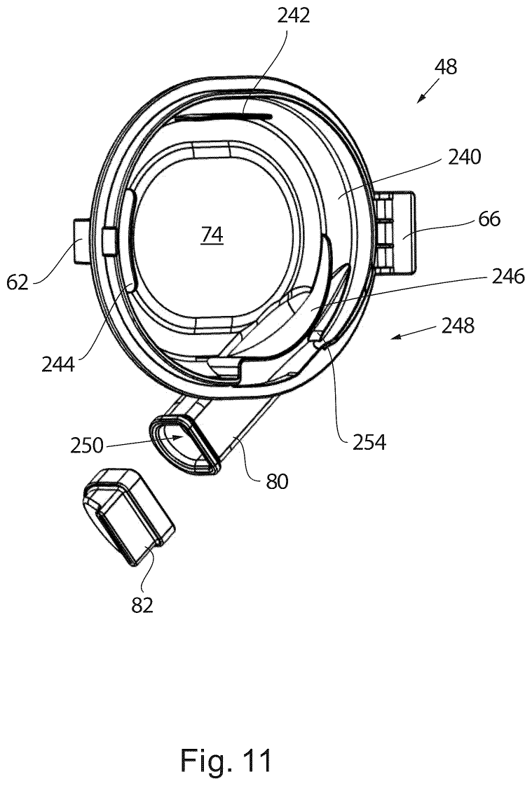

FIG. 11 is a perspective view of an internal or air filter facing surface 240 of cover 48 and shows valve 82 exploded therefrom. Internal surface 240 of cover 48 includes one or more flanges 242, 244, 246 that are positioned intermittently about surface 240 of cover 48 and extend in an inward axial direction toward cavity 138 of filter housing 42 when cover 48 is engaged therewith. At least a portion of each of flanges 242, 244, 246 are positioned and oriented to cooperate with an outwardly directed longitudinal end of air filter assembly 120 when air filter assembly 120 is engaged with cavity 138 and maintain a generally centrally disposed position of filter assembly 120 relative to the interior surface 200 of filter housing 42 when filter assembly 120 is disposed therein and cover 48 is oriented in the closed position relative to filter housing 42. Interior surface 240 of cover 48 defines a debris catch 248 that is oriented radially outboard relative to flange 246 and is fluidly connected to a passage 250 defined by debris tube 80. Debris catch 248 is positioned on cover 48 so as to be generally aligned with intake 198 (FIG. 8) defined by filter housing 42. Debris catch 248 includes a diverter 254 that is constructed and oriented to direct debris carried upon the intake flow stream, and which travels circumferentially around filter assembly 120, into debris tube 80 and toward vent 82. At least a portion of flange 246 has a volute or spiral shape that extends into gap 204 (FIG. 7) proximate debris catch 248 such that flange 246 is further constructed to separate debris from the air flow thereacross and direct collected debris proximate thereto into debris tube passage 250 of debris tube 80.

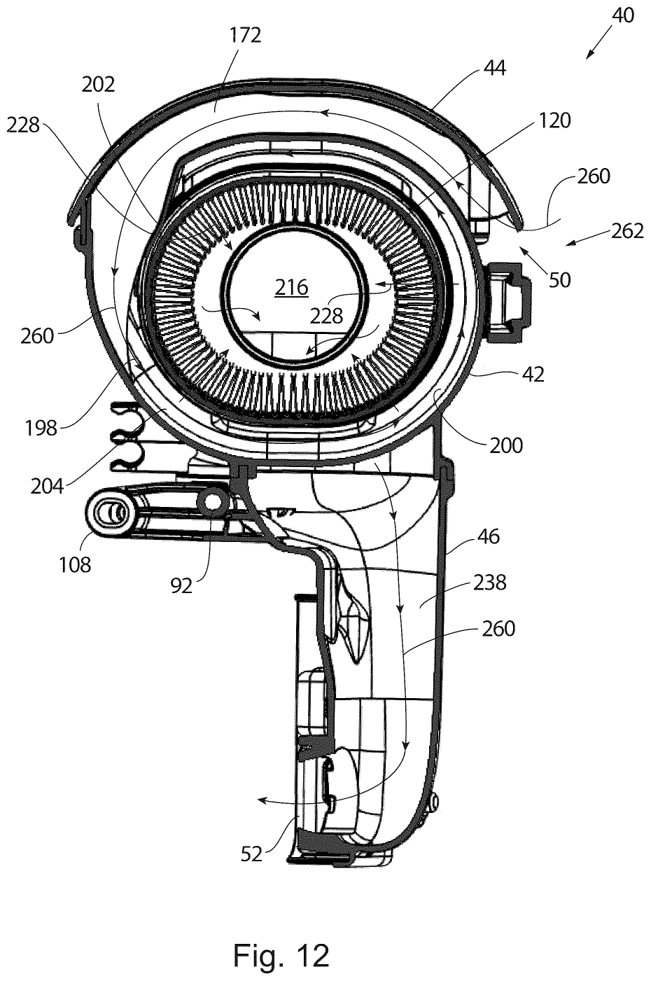

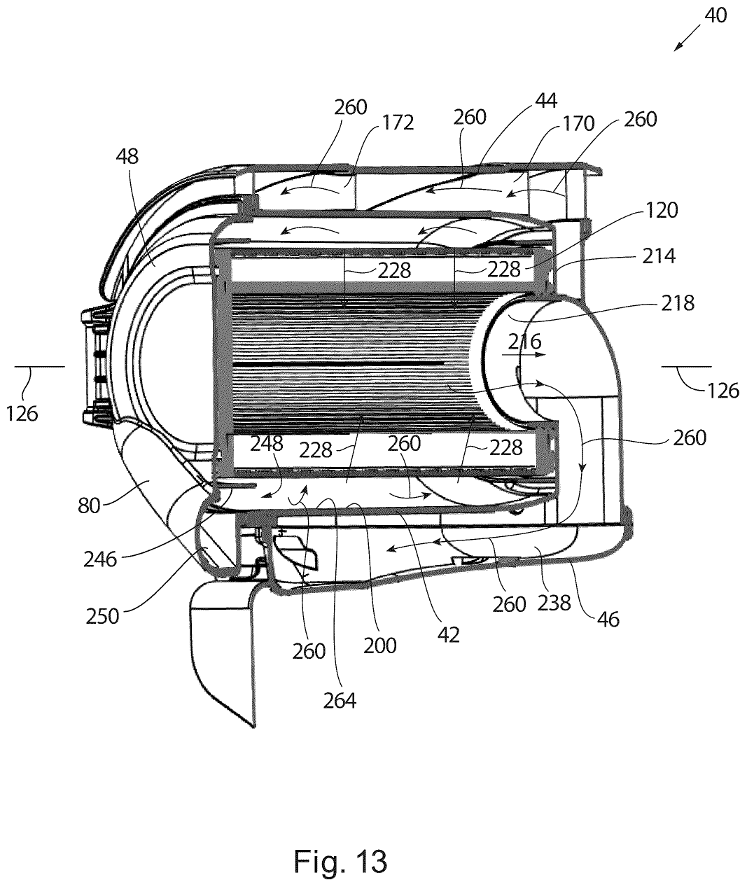

Referring to FIGS. 12 and 13, ambient air, indicated by arrow 260 enters air cleaner assembly 40 at the opening 262 of tunnel 50 defined by the offset or spaced cooperation of filter housing 42 and shroud 44. Air flow 260 passing through tunnel 50 is directed toward the interior facing surface 240 of cover 48 of air cleaner assembly 40 as air flow 260 progresses away from longitudinal inlet opening 262 defined by air cleaner assembly 40 and toward the elongate inlet 198 defined by filter housing 42. Once in gap 204 between filter assembly 120 and surface 200 of filter housing 42, airflow 260 progresses in a cyclonic flow therethrough whereas dirt and debris associated therewith is directed toward and impinges upon and interacts with debris catch 248 (FIG. 11) and flange 246 associated with the interior surface 240 of cover 48. Debris that bypasses debris catch 248 and/or flange 246 upon its initial introduction to gap 204 and which is light enough and/or initially axially offset from debris catch 248 and flange 246 so as to not impinge thereupon, is carried circumferentially around filter assembly 120, impinged upon ramped wall 202, and axial and radially directed for subsequent interaction with debris catch 248 and/or flange 246 and subsequent radial passage through filter assembly 120.

As shown in FIG. 13, in a preferred embodiment, at least a bottom portion of interior surface 200 of air filter housing 42 is tapered toward cover 48 such that heavier debris that may settle thereupon is encouraged to translate toward cover 48 and debris catch 248 and flange 246 associated therewith. Debris not initially captured and directed into debris tube 250 by debris catch 248 and/or flange 246 is centripetally separated from airflow 260 as it progresses circumferentially about gap 204. After the initial debris filtration associated with the cyclonic flow of airflow 260 about air filter assembly 120 and its interaction with and/or impingement upon the structures of debris catch 248 and flange 246, air flow 260 is directed in a radial direction, indicated by arrows 228, through air filter assembly 120 and toward opening 216 formed in partition 214 of filter housing 42 for further filtration thereof. The filtered airflow 260 progresses from opening 216 in a generally downward direction and passes into cavity 238 defined by filter housing support 46. Any flow associated with vent 92 defined by filter housing support 46 combines with airflow 260 and exits air cleaner assembly 40 at outlet 52 and to an underlying portable power tool and/or internal combustion engine associated therewith. A cyclonic airflow associated with gap 204, passage through air filter assembly 120, and the contribution of an axial flow vectors and air flow accelerations imparted by baffles 170, 172 and areas 194, 196 toward cover 48 encourages debris carried upon the airflow to travel toward debris catch 248 and flange 246 associated therewith defined by cover 48 for expedient expulsion of the debris from air cleaner assembly 40 via valve 82 associated with the distal end of debris tube 80. The horizontal orientation of filter assembly 120, the extension of ramped wall 202 toward air filter assembly 120, and the tapered construction associated with the floor 264 defined by surface 200 of filter housing 42 further encourages translation of any debris ingested into air cleaner assembly 40 toward debris catch 248, flange 246, for favorable expulsion of the debris from air cleaner assembly 40 prior to ingestion of such debris by underlying tools and/or equipment and/or fouling of non-circular air filter assembly 120.

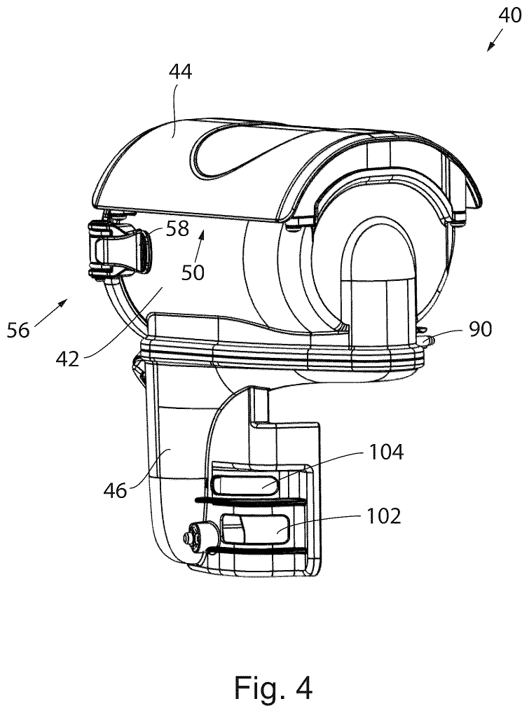

FIGS. 14 through 19 show air cleaner assembly 40 secured to an underlying exemplary portable power equipment or tool in the form of an internal combustion engine 270. Engine 270 includes a crankcase 272, a recoil 274, a fuel tank 276, and an exhaust or muffler 278 that are generally disposed about air cleaner assembly 40. A vent tube 280 fluidly connects the volume of crankcase 272 to vent 92 (FIG. 9) associated with filter housing support 46. Another vent tube 282 vents vapors from fuel tank 276 toward vent 90 (FIG. 4) defined by air filter housing 42. A fuel shutoff lever 284 and an engine choke lever 286 pass through respective openings 102, 104 defined by filter housing support 46 so as to allow user interaction therewith. A throttle lever 288 is disposed generally beneath filter housing support 46 and is accessible to the user to manipulate the speed of operation of engine 270. Engine 270 includes an on-off switch 290 and a pull cord 292 associated with initiating operation of engine 270. Although shown as what is commonly understood as a manually started engine, is appreciated that engine 270 could be configured to support electronic starting and operation thereof. For instance, fuel shut off valve 284 could be provided as an automatic solenoid, choke lever 286 could be provided as an electric motor, throttle lever 288 could be fixed or electrically driven, and on/off switch 290 could be provided as a key or switch start having on/off/stat respective positions.

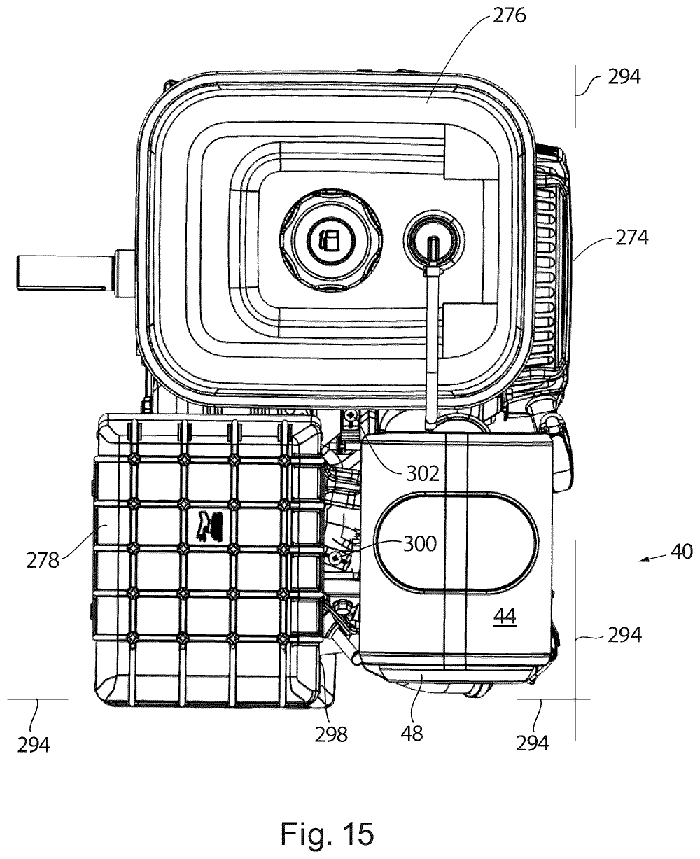

FIGS. 15-19 show various imaginary boundary lines, indicated by lines 294, associated with the exterior most structures defined by discrete portions of underlying internal combustion engine 270. As indicted by imaginary boundary lines 294, air cleaner assembly 40 is preferably substantially and/or entirely within the respective three-dimensional footprint defined by engine 270 and the respective fuel, exhaust, crankcase, and starting systems defined thereby. Such a consideration provides a greater protection of air cleaner assembly 40 from impacts and/or incidental contacts with other tools and/or equipment associated with the operating environment as well as transport and storage environments.

Although provided in a substantially compact form factor relative to the underlying assemblies defined by engine 270, air cleaner assembly 40 is supported thereby in a manner that does not interfere with user interaction with underlying adjustable components associated with construction and/or operation of the throttle assembly and/or the internal combustion engine. For instance, as shown in FIG. 15, air cleaner assembly 40 is maintained in a slightly spaced relation to a sidewall 298 of muffler 278 so as to allow user interaction with operators or fasteners, such as a screw 300 associated with a throttle sheath clamp, and/or a screw 302 or cable mount associated with securing the throttle cable relative to a respective lever and associated with the speed of operation of the underlying internal combustion engine.

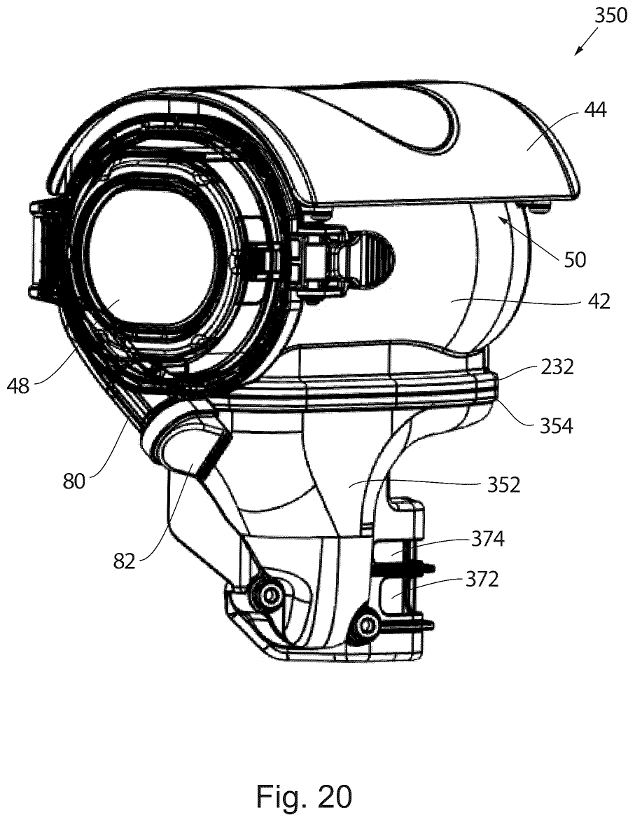

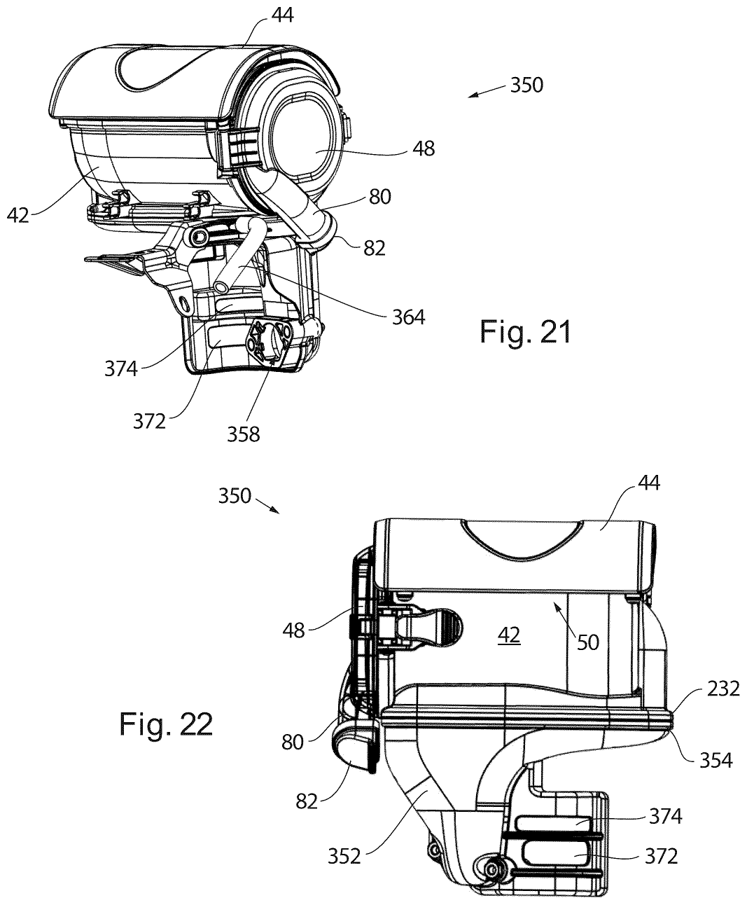

As shown in FIG. 16, air cleaner assembly 40 is attached to throttle body 304 such that a fuel shut off valve 284 and choke valve 286 are conveniently accessible for user interaction therewith. One or more bolts or nuts 306, 308 engage or cooperate with the throttle body 304 to secure filter housing support 46, and thereby filter housing 42 and shroud 44, relative to the underlying engine 270. It is appreciated that respective sleeves may be provided and configured to cooperate with the underlying fastener arrangement to mitigate overtightening of the respective fastening devices and/or damage to the respective filter housing support 46, 352 (FIGS. 20-24). Generally beneath and/or behind air cleaner assembly 40, one or more throttle adjustment or set screws 310, such as for setting engine idle or full throttle positions associated with throttle body 304, can be conveniently accessed and adjusted without requiring removal or displacement of air cleaner assembly 40 relative to the underlying engine 270. As such, while air cleaner assembly 40 is positioned closely relative to the underlying more structurally rigid assemblies of engine 270 to protect the air cleaner assembly 40 from damage during operation of engine 270, air cleaner assembly 40 is connected to engine 270 in a manner that does not interfere with user interaction with air cleaner 40 and/or the discrete operating and adjustment controls associated with the underlying internal combustion engine.

FIGS. 20-23 show an air cleaner assembly 350 according to another embodiment of the present invention. Air cleaner assembly 350 includes filter housing 42, shroud 44, and cover 48 that movably cooperates with filter housing 42 and is configured to receive an elongate, oblong, or non-circular air filter or air filter assembly 120 within filter housing 42 in the same manner and operable with the same attenuate objectives and advantages disclosed above. Air cleaner assembly 350 includes an elongate air intake tunnel 50 that extends between shroud 44 and filter housing 42 for communication of ambient air into the internal cavity defined by air filter housing 42 such that rotation and longitudinal axial directing of the ambient air is initiated within tunnel 50 and continues into the cavity defined by air filter housing 42.

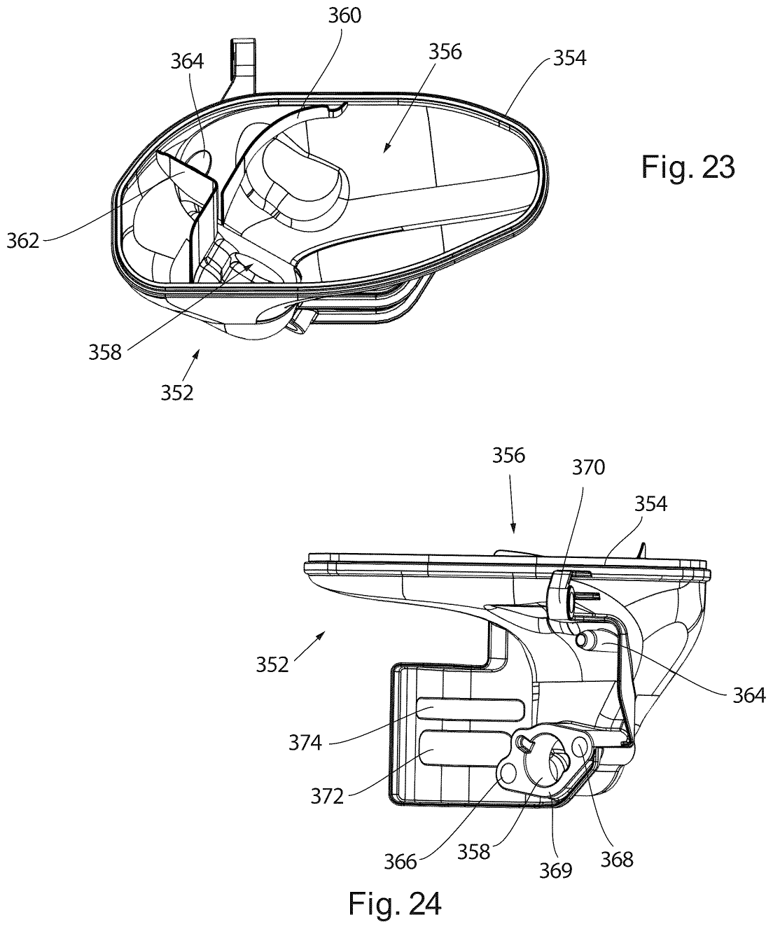

Referring to FIGS. 23-24, air cleaner assembly 350 includes a filter housing support 352 that is dissimilar to filter housing support 46 as disclosed above. Although filter housing supports 46, 352 exhibit many common features, filter housing support 352 is provided in a more vertically compact form factor in filter housing support 46 (FIG. 9). Filter housing support 352 includes an upwardly directed lip 354 that is constructed to scalingly cooperate with the downwardly depending skirt 232 (FIG. 9) of filter housing 42 in the same manner as filter housing support 46 (FIG. 9). Filter housing support 352 defines a cavity or passage 356 that is bounded by lip 354 and which extends to a discharge opening or outlet 358 that is constructed to overlie an inlet of an underlying throttle body.

One or more baffles 360, 362 are formed within passage 356 and oriented to manipulate a pressure associated with a port 364 defined by filter housing support 352 and is operable in a manner similar to the operation of port 92 as disclosed above with respect to venting an underlying crank case. One or more bosses 366, 368, 370 are defined by filter housing support 352 and positioned and shaped to accommodate securing of filter housing support 352 to an underlying internal combustion engine. One or more openings 372, 374 are formed in filter housing support 352 and constructed to cooperate with the underlying operating systems such as fuel shut off valves and/or choke adjustment valves associated with operation of the underlying engine.

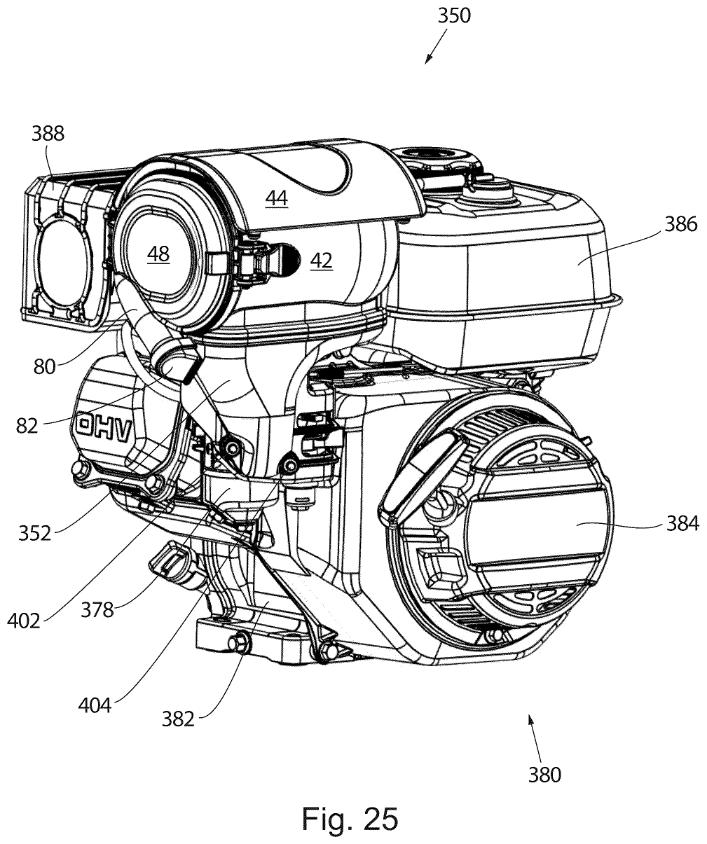

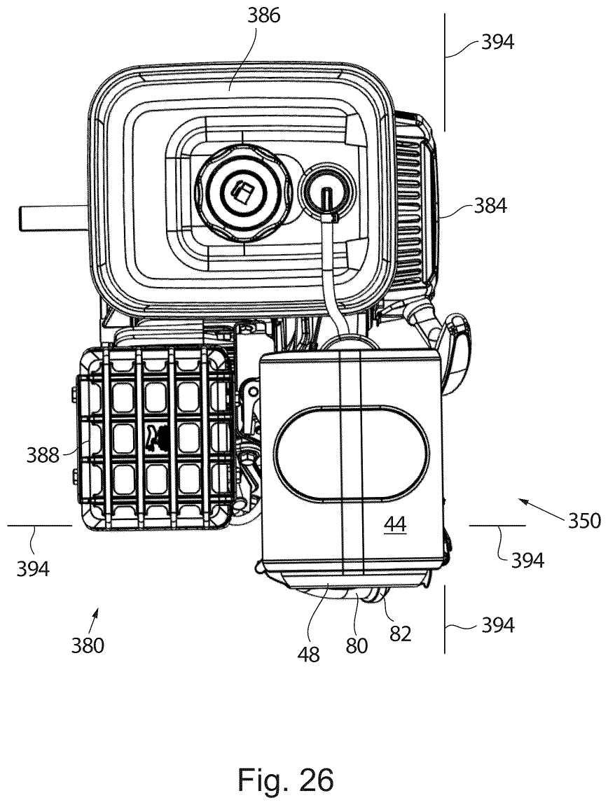

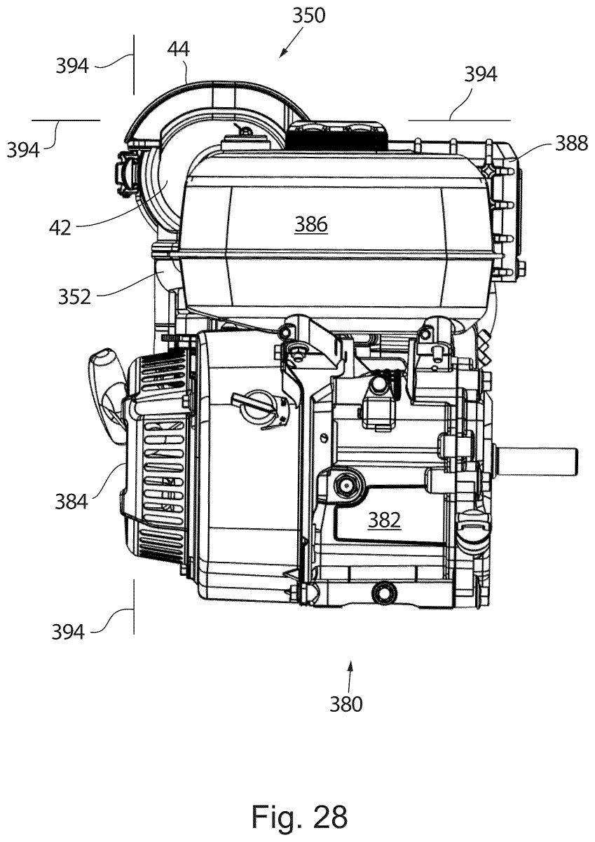

FIGS. 25-29 show various views of air cleaner assembly 350 secured to a throttle body 378 of an underlying internal combustion engine 380. Like engine 270 described above, engine 380 includes a crankcase 382, a recoil 384, a gas or fuel tank 386, and an exhaust or a muffler 388. It should be appreciated that engine 380 is generally smaller in size and displacement and rated output relative to engine 270 such that a lesser portion of air cleaner assembly 350 associated with engine 380 lies within the spatial footprint associated with various imaginary boundaries, indicated by imaginary boundary lines 394 of the ancillary systems or components of engine 380. Said in another way, portions of air cleaner assembly 350 extend beyond imaginary boundary lines 394 defined by the underlying crankcase 382, recoil 384, gas or fuel tank 386, and muffler 388 systems. Preferably, air cleaner assembly 350 extends respective distances beyond imaginary boundary lines 394 only distances sufficient to accommodate user interaction with the discrete adjustment mechanisms and/or operating mechanisms associated with the operation of the underlying engine 380.

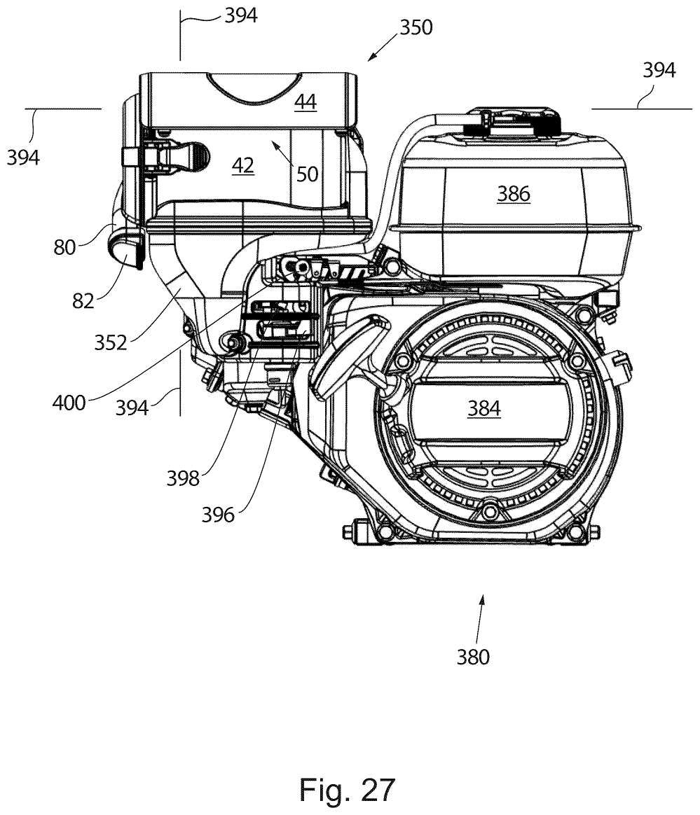

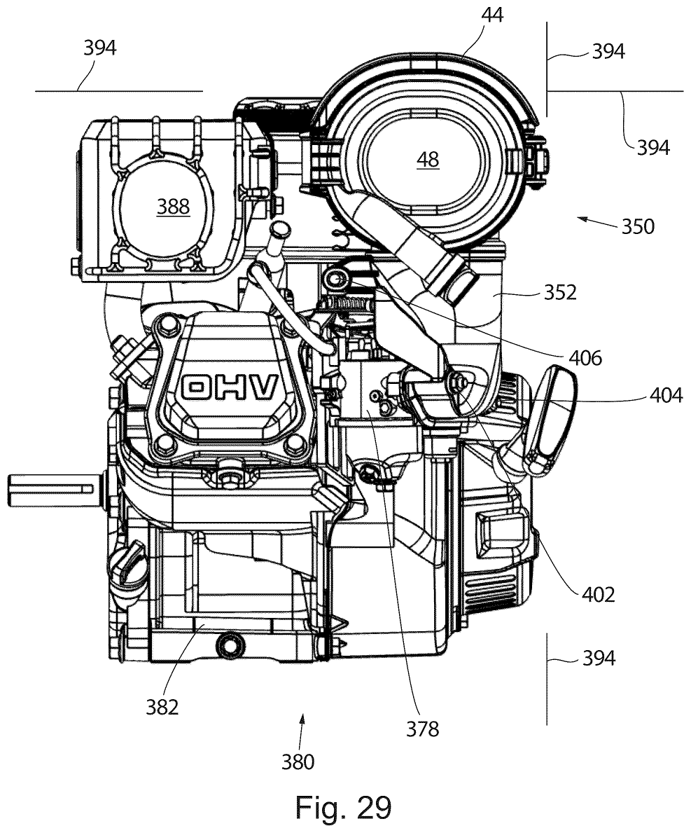

As shown in FIG. 27, a fuel shut off valve 396 and a choke valve 398 are readily operable via openings 372, 374 defined by filter housing support 352 as is a throttle stop screw 400 disposed generally underneath air cleaner assembly 350. Referring to FIGS. 25 and 29, one or more fasteners or nuts 402, 404 secure filter housing support 352 relative to underlying throttle body 378 via cooperation with respective bosses 366, 368 (FIG. 24) defined by filter housing support 352. Similarly, a fastener 406 (FIG. 29) cooperates with boss 370 (FIG. 24) defined by filter housing support 352 and improves the robust nature associated with securing filter housing support 352 relative to the underlying engine 380 such that air filter housing support 352 provides a secure and robust connection of filter housing 42, shroud 44, and cover 48 relative to underlying internal combustion engine 380.

Although two filter housing supports 46, 352 are shown in the various drawings, it is appreciated that filter housing supports having other constructions are envisioned wherein such supports are configured to cooperate with the underlying construction of an internal combustion engine having constructions other than those shown. Such a consideration reduces manufacturing costs by providing air filter housings 42 in the manner constructed above that can be employed for different engine outputs and configurations via utilization of discrete air filter housing supports to cooperate with respective alternate engine configurations with a common air filter, shroud, and cover assemblies.

The utilization of non-circular air filter assemblies, air filter housings that generate cyclonic horizontally oriented air flows, debris catches disposed in a longitudinal end of the discrete air cleaner assemblies, and vertically sloped or tapered air filter housing floors each contribute to accommodating usage of oblong air filter assemblies that provide greater surface areas than round air filter assemblies and encourage the passage of debris carried on intake flows toward a debris discharge port defined by the air cleaner assembly to effectuate efficient expulsion of air flow debris from the air cleaner assembly prior to mitigate pollution of the air filter assembly thereby communicating a sufficient flow of filter air to underlying power tools, equipment, and/or internal combustion engine systems. Such considerations prolong the usable service life of the respective air filter assembly and improve protection of underlying tools, equipment, and machines by maintaining a desired flow and filtration of the ambient air to underlying devices.

Therefore, one embodiment of the present invention defines an air cleaner assembly having an oblong cross section shape and that is shaped to cooperate with non-circular or oblong air filters or air filter assemblies. The air cleaner assembly includes an intake tunnel that passes around a portion of an exterior of a filter housing body and that overlies an air inlet into the filter housing body. The intake tunnel initiates rotational or cyclonic movement of air directed into the cleaner assembly. A cover moveably cooperates with a longitudinal end of the filter housing assembly and allows selective access to a non-circular air filter disposed therein. The air cleaner assembly is preferably constructed to allow visual inspection of the interior of the air cleaner assembly without operation of the cover. The air cleaner assembly includes a filter housing mount that defines an air duct that communicates filtered air toward an underlying power tool or internal combustion engine and that at least partially supports the air cleaner assembly relative to underlying equipment. During operation of the air cleaner assembly, intake air, and debris carried thereupon, enters the air cleaner assembly and is directed toward a debris collection port and subsequently in a cyclonic direction about the air filter such that the air flow preferably circumscribes the air filter prior to passing radially through the air filter and toward the underlying portable powered tool or device.

Another embodiment of the invention includes an air cleaner assembly having a filter housing assembly that is defined by a longitudinal axis and has an oblong cross section shape that extends along the longitudinal axis such that the filter housing assembly defines a cavity shaped to receive a non-circular air filter. An elongate intake opening is formed along a portion of the filter housing assembly and a discharge opening is formed in a longitudinal end of the filter housing assembly that is fluidly connected to the cavity and radially offset from the elongate intake opening such that air moving from the elongate intake opening toward the discharge opening moves circumferentially about the cavity before passing through a non-circular air filter disposed therein.

A further embodiment of the invention that is usable or combinable with one or more of the features, aspects, or embodiments disclosed above defines an air cleaner assembly having a filter housing defined by a first end and a second end and a non-circular wall extending therebetween. The non-circular wall is defined by respective opposing curved ends and generally planar sections therebetween such that the filter housing is shaped to receive a non-circular air filter therein. An air inlet is formed through the non-circular wall and a cover is movably connected to the first end of the filter housing and shaped to allow a non-circular air filter to be associated with a cavity defined by the filter housing. An air outlet is formed in the second end of the filter housing such that a cyclonic air flow is generated between the housing and a non-circular air filter disposed in the cavity. The air cleaner assembly preferably includes an inspection window that allows visual inspection of the cavity when the cover is closed. In a preferred aspect, the inspection window is provided by constructing the cover or a portion thereof of a translucent or transparent material.

Another embodiment of the invention that is usable or combinable with one or more of the above features, aspects, or embodiments discloses a method of forming an air cleaner assembly for portable power equipment. The method provides a filter housing that is defined by a longitudinal axis and an oblong cross section shape that extends along the longitudinal axis such that the filter housing is shaped to receive a non-circular air filter. An outlet is formed in an end wall of filter housing and an inlet passage is formed in an edge wall of the filter housing. An intake tunnel extends over the inlet passage and extends in a circumferential direction about a portion of the air filter housing and is shaped to initiate rotational and axial translation of air communicated toward the inlet passage.

The present invention has been described in terms of the preferred embodiments. The embodiments disclosed herein are directed to the assembly as generally shown in the drawings. It is recognized that equivalents, alternatives, and modifications, aside from those expressly stated, to the embodiments summarized, or the embodiment shown in the drawings, are possible and within the scope of the appending claims. The appending claims cover all such alternatives and equivalents.

What is claimed is:

1. An air cleaner assembly comprising:
a filter housing assembly defined by a longitudinal axis and having an oblong cross section shape that extends along the longitudinal axis such that the filter housing assembly defines a cavity shaped to receive a non-circular air filter;
an elongate intake opening formed along a portion of the filter housing assembly; and
a discharge opening formed in a longitudinal end of the filter housing assembly that is fluidly connected to the cavity and radially offset from the elongate intake opening such that air moving from the elongate intake opening toward the discharge opening moves circumferentially about the cavity before passing through a non-circular air filter disposed therein.

2. The air cleaner assembly of claim 1 wherein the filter housing assembly is further defined by a filter housing body and a shroud that extends along a portion of the filter housing body and defines a gap between the filter housing body and the shroud.

3. The air cleaner assembly of claim 2 further comprising at least one baffle formed between the filter housing body and the shroud and that extends in a helical direction away from the discharge opening

4. The air cleaner assembly of claim 1 further comprising a cover that is movably connected to another longitudinal end of the filter housing assembly that is opposite the discharge opening.

5. The air cleaner assembly of claim 4 further comprising a viewing window formed by the cover.

6. The air cleaner assembly of claim 5 further comprising a light source disposed proximate the cover and oriented to illuminate a portion of the cavity.

7. The air cleaner assembly of claim 4 further comprising a debris catch and debris collection passage defined by the cover.

8. The air cleaner assembly of claim 7 further comprising a flange extending from the cover proximate the debris catch and configured to direct debris into the debris collection passage.

9. The air cleaner assembly of claim 1 further comprising ramped wall formed along an interior facing surface of the filter housing assembly along the longitudinal direction and in a radial direction toward a centerline of the cavity.

10. The air cleaner assembly of claim 1 further comprising a mount body that defines a duct constructed to be fluidly connected to the discharge opening of the filter housing assembly and is constructed to be secured to one of a throttle body and an electrically powered tool.

11. The air cleaner assembly of claim 10 wherein the mount body includes at least one boss that is constructed to be secured to an internal combustion engine at a location offset from the throttle body when the mount body is secured to a throttle body.

12. An internal combustion engine equipped with the air cleaner assembly of claim 1.

13. An air cleaner assembly comprising:
a filter housing defined by a first end and a second end and a non-circular wall extending therebetween, the non-circular wall being defined by respective opposing curved ends and generally planar sections therebetween such that the filter housing is shaped to receive a non-circular air filter therein;
an air inlet formed through the non-circular wall;
a cover movably connected to the first end of the housing and shaped to allow a non-circular air filter to be associated with a cavity defined by the housing;
an air outlet formed in the second end of the housing such that a cyclonic air flow is generated between the housing and a non-circular air filter disposed in the cavity; and
an inspection window that allows visual inspection of the cavity when the cover is closed.

14. The air cleaner assembly of claim 13 further comprising a light source disposed proximate the inspection window.

15. The air cleaner assembly of claim 13 wherein at least a portion of the cover is transparent and defines the inspection window.

16. The air cleaner assembly of claim 13 wherein the cover is non-circular and includes a hinge arm and latch boss disposed at opposing longitudinal edges thereof.

17. The air cleaner assembly of claim 13 further comprising a shroud that overlies a portion of the filter housing and defines an opening that is at least 15 radial degrees from the air inlet formed in the non-circular wall.

18. The air cleaner assembly of claim 17 further comprising at least one baffle that has a helical shape and is formed between the shroud and the filter housing.

19. The air cleaner assembly of claim 13 further comprising a debris catch defined by the cover.

20. The air cleaner assembly of claim 19 further comprising a flange disposed proximate the debris catch and exposed to the cyclonic air flow to direct debris into the debris catch.

21. The air cleaner assembly of claim 19 further comprising a valve disposed over an open end of the debris catch that is operable to vent debris from the filter housing when the vent is open.

22. The air cleaner assembly of claim 13 further comprising a diverter wall that extends in a longitudinal direction along a portion of an interior surface the filter housing proximate the air inlet and which extends toward a non-circular air filter disposed in the cavity.

23. The air cleaner assembly of claim 13 further comprising a filter housing mount disposed beneath the filter housing and that defines a duct that is fluidly connected to the air outlet defined by the filter housing.

24. An internal combustion engine equipped with the air filter assembly of claim 11.

25. A method of forming an air cleaner assembly, the method comprising:
providing a filter housing defined by a longitudinal axis and an oblong cross section shape along the longitudinal axis shaped to receive a non-circular air filter;
forming an outlet in an end wall of filter housing;
forming an inlet passage in an edge wall of the filter housing; and
forming an intake tunnel that extends over the inlet passage and that extends in a circumferential direction about a portion of the filter housing and is shaped to initiate rotation of air communicated toward the inlet passage.

26. The method of claim 25 wherein forming the intake tunnel further comprises providing a shroud that removably cooperates with the filter housing.

27. The method of claim 25 further comprising providing a movable cover that cooperates with a second end wall of the filter housing and allows selective access to a non-circular air filter disposed in the filter housing when the movable cover is open.

28. The method of claim 27 further comprising forming at least a portion of the movable cover of a transparent material.

29. The method of claim 27 further comprising forming a debris vent in the movable cover.

30. The method of claim 29 further comprising forming a debris guide baffle on an interior facing surface of the movable cover.

31. The method of claim 30 further comprising forming a flange proximate the debris guide baffle and configured to direct debris toward the debris vent.

32. The method of claim 25 further comprising forming a ramp wall along an interior facing surface of the filter housing that is aligned with the longitudinal axis, is proximate to and downstream of the inlet passage, and extends radially toward a non-circular air filter.

33. The method of claim 25 further comprising forming at least one deflection baffle in the intake tunnel and directing the at least one deflection baffle toward the inlet passage.

34. The method of claim 25 further comprising providing air filter housing support that defines an air duct that extends between the outlet of the filter housing and is constructed to be secured to an intake of one of a power tool and a throttle body of an internal combustion engine.
